(19) United States
(12) Patent Application Publication
(10) Pub. No.: US 2007/0224580 A1
(43) Pub. Date: Sep. 27, 2007

(54) METHOD FOR ASSESSING A MENTAL FUNCTION ACTIVITY PROFILE

(76) Inventor: William J. McFaul, Jackson, NJ (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/677,306

(22) Filed: Feb. 21, 2007

Related U.S. Application Data
(60) Provisional application No. 60/776,148, filed on Feb. 23, 2006.

(51) Int. Cl. G09B 19/00

(52) U.S. Cl. 434/236; 434/219

(57) ABSTRACT

A method for assessing the mental function activity (MFA) of an individual. A person's mental activity is gauged through the application of tests designed to produce results indicative of mental activity. These tests can be in the form of questionnaires, physical exams, or a combination of both. The results are evaluated and categorized and can be used for various applications.

This Application claim benefit of priority to U.S. Application Ser. No. 60/776,148, filed on Feb. 23, 2006, the contents of which are incorporated herein.

### BACKGROUND OF THE INVENTION

1. Field of Invention

The invention relates to the field of physical and psychological profiling. In particular, the invention relates to a method and system for the assessment and categorization of mental function activity in people.

2. Description of the Related Technology

There are a variety of physiological and psychological problems that affect human beings. Man of these problems can appear unrelated. However, recent studies have shown that the body and the mind are intertwined, in ways that can directly affect each other. This interaction could produce significant effects in the way that physicians and psychologists handle patients.

Additionally, many behavioral characteristics can influence future behavior and decisions of people. Diagnosing certain categories of mental activities can be useful in a variety of fields and prove to be beneficial for both economical and health purposes. Current methods for evaluating behavior fall short in addressing the underlying factors that relate to a person's mental function activity (MFA) classification. There are currently tests used that establish a person's Intelligence Quotient (IQ), or Emotional Intelligence. Additionally, there are tests that are used to gauge one's personality. However, despite the various traits of individual that these exams are designed to determine they do not take into account or even attempt to gauge the mental function activity of individual.

Although there are a number of physiological testing devices that provide indications of brain activity (EEG, MRI, Functional MRIs, CT Scans, PET Scans, MEGs, etc.) it is not evident that any of these devices or other forms of psychological/physiological testing actually establishes a standard of activity, categorizes activity, or differentiates between the probable impacts of those comparisons in order to evaluate a person's future performance. These tests may broadly measure actual activity in the brain, but fail to quantify or establish a frame of reference in which to deal with the information.

Therefore, there remains a need for effectively assessing and categorizing individuals for determining their potential success in position of employment.

### SUMMARY OF THE INVENTION

An object of the instant invention is to effectively assess and categorize individuals for placing and determining their potential success in a position of employment.

Another object of the invention is to provide a method for and categorizing the mental function activity of a person.

One aspect of the present invention can be a method for selecting an individual for a position of employment comprising the steps of: establishing characteristics applicable to a position of employment; preparing a mental function activity test based on the characteristics; administering the mental function activity test to a pool of potential employees; assessing results of the mental function activity test; and electing an employee based upon the results of the mental function activity test.

Another aspect of the present invention can be, a method for categorizing assessment results of mental function activity comprising the steps of: establishing a plurality of categories based upon a pool of characteristics; organizing the plurality of categories to correspond to a clock face; administering a test to a person; evaluating results of the test administered to the person; and utilizing the results to place the person into one of the plurality of categories.

Yet another aspect of the invention can be a method for assessing a mental function activity of an individual comprising: applying a test to an individual, wherein the test is designed to illustrate menu function activity characteristics; and evaluating results of the test, wherein the results are used to place the individual into a category and the category represents a level of mental function activity.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWING

FIGS. 1a and 1b are images showing position emission tomography test results of the brain activity of a normal individual and an individual diagnosed with Attention Deficit Hyperactivity Disorder.

FIG. 2 is a chart illustrating a method of categorizing Mental Function Activity (MFA) results.

FIG. 3 is a flow chart illustrating a sample process for establishing categories and applying tests for a position of employment.

FIG. 4 shows a table having various character traits that can be used in evaluating MFA and establishing categories.

FIG. 5 is a chart illustrating a method of categorizing Body Function Rate (BFR).

FIG. 6 is a chart used for illustrating both the MFA and BFR activities of a person.

### DETAILED DESCRIPTION OF THE INVENTION

The invention primarily dwells in the realm of human neuroscience as well as psychological behavior and the potential physiological and behavioral impacts. The process allows for the assessment, and interpretation of Mental Functioning Activity (MFA), also referred to as How People Think (HPT). MFA is the quality and characterization of how and what data, information and other inputs individuals absorb in their brains and what potential responses to these various stimuli will be based upon the rate of activity in the brain.

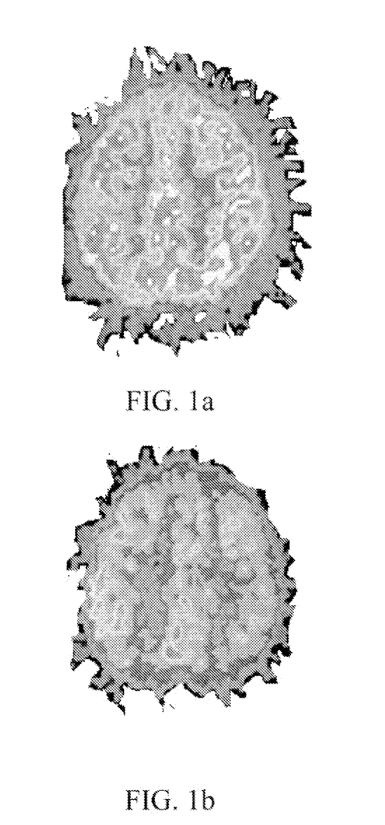

A person'response to stimuli, i.e. his or her environments, is based on the variability of the brain's activity rate and his or her interpretation of the information. An illustrative example of brain activity is illustrated in FIGS. 1a and 1b. FIG. 1a shows the brain activity of a non-attention deficit-hyperactivity disorder (ADHD) adult, while FIG. 1b shows the brain activity of a person having ADHD. From the Figures it can be seen that the brain activity of one individual is more pronounced than the person afflicted with ADHD. Although this illustrates brain activity, it does not capture the nuances between different gradations of brain activity and how a person response to environmental stimuli.

The invention enables the assessment and categorization of people based on their mental process rates and bands of thought processes such as focus, awareness, emotion, stress and anger, etc. Mental Function Activity is a term used to illustrate a spectrum of possible mental and behavioral characteristics correlated with their actual or categorized brain activity. For example some characteristics that make up MFA are Focus, such as obsession, over-focus, awareness and disinterest; Temperament such as rage, anger, aversion, and disenfranchisement; Concern, such as fright, fear, sadness and despair; Happiness, such as resentment, bitterness, joy, envy and avoidance; and Physical behavior, such as overly-active, active, lethargic and sedentary. MFA provides a gauge that helps ascertain a person's ability to dedicate greater or lesser focus on tasks and their ability to handle tasks. MFA can also be used as a gauge to determine potential physical health effects that have been shown to correspond to various levels of MFA. MFA can be used to help establish people's mental health for the purpose of diagnosis and/or treatment by mental health professionals. MFA can also be used as a gauge for determining a rate of activity of the body'immune system and other physiological activities. Furthermore, the various bands of thought process discussed above may have specific MFA levels attributed to them, and the MFA of the different bands of thought assessed individually.

By utilizing the processes, a person trained in the method can establish a profile of how an individual thinks, i.e. determine the MFA of the individual, and through this understanding can then take appropriate steps to enable an individual or group to behave in a more desirable fashion to better achieve whatever their intended goals or purposes, either the goals established by mental health practitioners or their current or potential employer. Furthermore, the positive behavioral adjustment can also be effectively implemented with groups of individuals who have been profiled utilizing the invented process.

The assessment, categorization and subsequent analysis will enable those familiar with the diagnosing method to compare these processes and activities to differentiate between how the people think within the categories and, based on the categorization, anticipate potential future health risks as well as placement within certain organizations and ability for accomplishing certain goals.

One method of identifying an individual's mental functioning activity profile comprises the steps of utilizing a test method to determine the placement of the individual'mental function profile into one of the categories established to meet the specific criteria for the purpose of the analysis. The person involved in diagnosing compares the differences between MFA within each of the categories to the standards established in advance of the analysis. The person also compares the differences between MFA within each of the categories to the standards established in advance of the analysis by the party(s) seeking to differentiate between individuals in order to select individuals most ideally suited to their particular need.

Although this process for diagnosing MFA primarily dwells in assessing mental and physical behavior, there is immense potential impacts/uses of the invented processes covering a broad spectrum of applications, including but not limited to psychiatry, psychology, disease diagnosis & treatment, pharmacology, child rearing, educational counseling, formal education, professional training, career and employment counseling, business strategy execution, organizational development, government, organized religion, and many other human endeavors.

Usages of the method for assessment can be applied to a variety of fields and applications. One field that it can be applied to is the field of psychology and psychiatry. In the field of Psychology and Psychiatry the method can be used to profile patients in comparison to the behavior of others, and to enable professionals to educate their patients and families regarding their status and to design a mutually acceptable treatment regimen (e.g. marriage counseling, sibling relationships, other scenarios requiring behavioral modification, etc.) The method can be used to create distinct training and educational options to prevent dysfunctional behavior or to treat existing conditions. The method can also be used to create a basis of understanding from which mental health professionals or physicians will be able to instruct their patients to perform self-analysis to detect less-than-desirable behavioral patterns as well as to pinpoint the origins of such existing behaviors. The method can be used to identify the existence and intensity of mental disorders such as clinical depression and seasonally affective disorder.

In the field of human resources the method can be used to match candidates for potential employment with job descriptions based on their MFA rather than just using personality traits. It can also be used to define performance capabilities to match desired outcomes when seeking to fill job vacancies. The method can be used to create customized or balanced teams to accomplish specific objectives, e.g. strategic planning, innovation, cultural transformations, etc. MFA profiles may be used to categorize people's capabilities to excel in performance in various roles in all industries and professions; e.g. business leaders, low enforcement professionals, teachers, government intelligence specialists, etc. The assessed MFA can be used in order to evaluate what types of decisions person will make in both a personal and business setting. People who fall into certain categories will be more likely to make certain types of decisions as opposed to other people (e.g. an aggressive—but well reasoned response vs. an aggressive—but impulsive response).

In the field of medicine and pharmaceuticals the method can be used in conjunction with additional testing in order to determine which medications are suited for individual categories of patients in order to obtain optimal outcomes as well as to match medications with MFA in order to possibly prevent side effects. The method may be used in conjunction with additional testing in order to determine when some medications may be inappropriate or may have become ineffective. The method can be used to provide patients with a frame of reference as to where they are and to use that point as a reference to indicate possible health risks. This same process can be used in indicate where individuals need to be in which category to minimize or eliminate health risks. Ideally the method can be used to provide patients with an understanding of the types and levels of stress distress they will experience based upon their category of MFA and the impact their categorization can have on the possibility of developing various illnesses and diseases which correspond to the individual's body/immune system (Body Function Rate-BFR). The method can also be used to provide a basis for pharmaceutical companies and manufacturers of herbal medications to create and test medications or products specific to categories of mental functioning activities. The method can be used to categorize the impact of biochemical changes alone or in combination with foods, medicines, herbs or other ingested, injected or absorbed elements. The method can also be used in order to evaluate possible neural and biochemical activity, such as possible hormonal issues as well those substances that have been ingested and assimilated into the body. Additionally, the method can be used to establish a nutritional plan for individuals in order to establish which food may or may not be better suited for a person's particular MFA and BFR.

In the field of education the process can be used to provide consultation to students (grade school through college) regarding career paths and/or curriculum selection based on MFA and, if deficiencies exist, alert the student or their parents of these weaknesses so behavioral modifications can be made. The method can be used to provide teachers and guidance counselors with categories in which students can be clustered in order to maximize their education and/or minimize behavioral problems.

In the field of business the method may be used to match the marketing process for any product or service with the appropriate MFA category in order to maximize sales. The method can be used to develop balanced surveys or polls based on MFA categories and to design such surveys or polls to target specific audiences for special needs.

In the legal field the method can be used to identify people by their MFA category in order to establish probabilities for what they might think or do. The method can be used to profile individual criminals based on their MFA category and a list of probabilities of what they might do can be based upon their MFA category. The method can also be used to profile individuals during jury selection processes.

With respect to the above potential applications, the instant inventive method involves the application of a test in order to evaluate the MFA of an individual. In particular, the evaluation of the MFA of individual is used in selecting the appropriate individual for a position of employment. The test may be a manual exam or a computerized questionnaire, or other evaluation test, such as an oral exam. If the test is administered on a computer, it may be distributed via the internet, or an software. It should be understood that the implementation of the method on a computer involves the usage of the processors, applications, etc. the understanding of which is known to those of skill in the art. These tests will result in the accumulation and compilation of information showing specific sets of thinking traits such as focus, awareness, emotion, anxiety, social skills, etc. When the test is scored and evaluated, the takes of the test are placed into predetermined categories that are indicative of an individual's MFA. Each category is established to indicate a set of mental functional activities within the brain. Each set of activities has assigned a spectrum of characteristics which differentiate how people think and consequently how they may potentially act given certain stimuli.

Additionally, it is also possible that a physical exam could be administered that can either by itself or in combination with a questionnaire be capable of diagnosing the MFA of a person. When using a physical exam, an EEG, position imaging tomography technique, or other brain imaging techniques may be used that identify activities in certain areas that are then correlated to certain tasks or stimuli from the outside. By then viewing and evaluating these images the person may then be placed into the proper category. For example brain activity, such as that shown in FIG. 1b, would be suggestive of someone who has a low MFA level.

An example of how this process can be used is in determining a person's potential for successfully completing a task. After the test is administered the results are compared to predetermined required criteria and/or desirable characteristics for a given task or assignment. The person's MFA results are compared against the desired and required MFA to successfully accomplish a defined task. This will provide a probability of that person's capacity to achieve success in the desired task or goal.

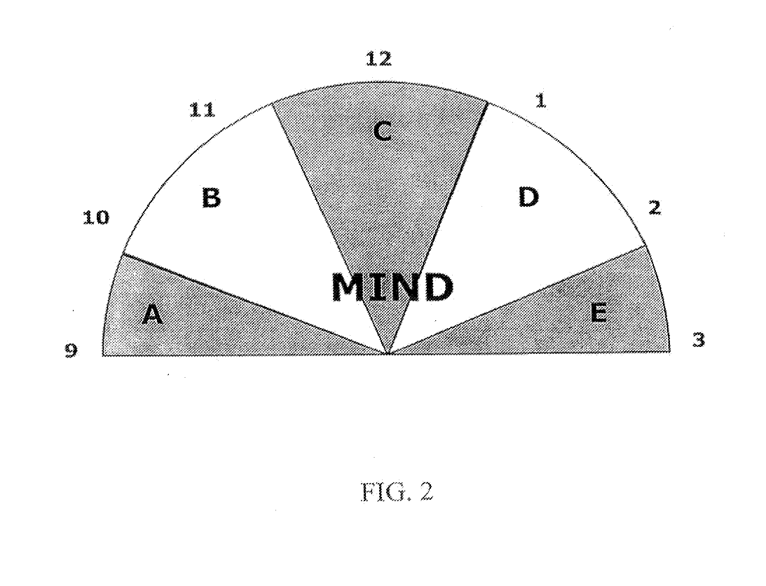

In evaluating MFA it is desirable to organize the results into different categories. The number of categories used for the basis of comparison can vary in number and degree depending upon the desired outcome of the process. It is possible to use any variety of system in which to organize the categories depending on the number of categories that are used. An example of a potential method, for categorizing the results of the MFA evaluation is shown in FIG. 2. FIG. 2 shows half of the face of a clock. The clock positions of 9, 10, 11, 12, 1, 2 and 3 are shown. The areas between the clock positions are labeled A-E, the labeling of A-E illustrates an alternative method for categorizing an individual using a chart.

The clock positions correspond to seven categories in which the spectrum of MFA can be subdivided. When using the clock face for psychiatric purposes in conjunction with diagnosing MFA, the categories used can be related to overall psychological make up. In this example, 9 represents a category for someone who has a MFA that exhibits characteristics of someone who has focus dysfunctions. 10 represents a category for someone who is overly focused and antisocial, the person may also be someone who fails to control their ability to focus due to lack of maturity. 11 represents a category for someone who is focused and methodical. 12 represents a category for someone who is flexible and collaborative. 1 represents a category for someone who may suffer from mild clinical depression. 2 represents a category for someone who may have severe clinical depression. 3 represents a category for someone who is mentally disadvantaged.

These categories can also be used when applying MFA in order to assist in evaluating a person's decision making ability. Decision-making, like other patterns of thought, is a process comprised of a sequence of intrinsic questions based on the MFA of the individual. For example a person's sequence of decision making in may be what→how→when→where→who. This type of decision making process is typical of individuals that are focused, for example people who would be placed between the 10 and 12 position on the clock shown in FIG. 2. Another sequence of thinking may be why→who→when→how, which is representative of less focused individuals who are more prone to action as opposed to facts. These are individuals who would be placed between the 1 and 2 position on the clock when being assessed. A person's MFA establishes arousal level tipping points and it also compensates for intensity levels based on facts, experience based on memory, and the ability to associate (cross) experiences and logic. Over focused people, people placed assessed at the 10 position, as apposed to focused ones placed at the 11 position, are more instinctive in their responses (i.e. cunning and manipulative in order to survive). They are, in essence, obsessively over focused and detached from emotions proportionate to the intensity of their focus. Less focused and under focused people, i.e. 1-2s are aloof, oriented to prompt actions and reactions (without thinking), inconsistent and prone to errors.

In FIG. 2, the categories of A-E are shown as possible alternative categories when evaluating the MFA of people for psychological purposes. For example, people who fall within the category A would be people who are extremely introverted, exhibit obsessive behavior or exhibit autistic symptoms. People placed into category B could be those people who can focus on a particular topic or issue with ease, but may be slightly withdrawn socially. These people may be very schedule oriented. A person in category C can be flexible, collaborative, innovative, insightful and able to function in an environment which necessitates their ability to alternate between various foci. A person in category D would lack focus, accepts mediocre results, backs enthusiasm, may be impetuous, and disfavors routine tasks. A person in category E may be undesirable due to total lack of focus, or he or she may exhibit signs of Attention Deficit Disorder.

It is also possible to provide a variety of tests that are able to provide scores of various levels of MFA. Alternatively, it may be possible to provide a standardized MFA score. This MFA score may be normalized to the general public in order to express a range of MFA scores. Specific tests directed towards different uses can be created and used to establish standards related to specific applications. These specialized results may then be standardized with respect to the general MFA levels. In the example provided below evaluation and application of diagnosed MFA is discussed with respect to a chief operating office.

### EXAMPLE 1

IN the following example the process for assessing the MFA of a candidate for a job and then using the assessed MFA for selecting the proper candidate is discussed. Assessment of the MFA of a candidate is based on the criterial established by the potential employers, not for personality traits, but for attributes dictated by how they will need to think in order to perform successfully and execute optimally their assigned tasks. For example, employers might typically seek an individual who has good communication skills, an excellent personality trait. However, depending upon the job, a company may be wiser to seek one who has a MFA that is indicative of someone who is collaborative, unbiased and thinks in terms of achieving optimal solutions. While a person may test well for having a personality which is outgoing and will probably display interpersonal skills, they may be risk adverse, reluctant to change and require hard facts for all aspects of project evaluations.

In FIG. 2 the clock positions can correspond to seven categories in which the spectrum of MFA can be subdivided in conjunction with its application to people applying for a position of employment. Using the clock face shown in FIG. 2, 9 represents a category for someone who has a MFA that exhibits characteristics that are profoundly withdrawn and isolated. 10 represents a category for someone who may have a tendency to over focus to the point of being obsessive or bordering on it. 11 represents a category for someone who is focused and methodical. 12 represents a category for someone who is flexible and collaborative. 1 represents a category for someone who is mildly ambitious and slightly enthusiastic. 2 represents a category for someone who is under focused and unreliable, as well as potentially depressed. 3 represents a category for someone who is emotionally unstable.

The categories of A-E can be used as possible alternative categories, instead of the clock positions, when evaluating the MFA of people who are interested in a position of employment. For Example, people who fall within the Category of A would be undesirable due to functional limitations associated with being extremely introverted or exhibiting autistic symptoms. People placed into category B could be those people who are logical, and who can focus on a particular topic or issue with ease. These people may also be rigid, formalistic and primarily focused upon facts. They may additionally be intolerant of errors or interruptions, and be very schedule oriented. A person in category C can be flexible, collaborative, innovative, visionary like, insightful and able to perform well in a variety of different tasks. A person in category D would lack focus, accept mediocre results, lack enthusiasm, may be impetuous, attempt to perform multiple tasks simultaneously and/or disfavor routine tasks. A person in category E may be undesirable due to total lack of focus, or he or she may exhibit signs of Attention Deficit Disorder.

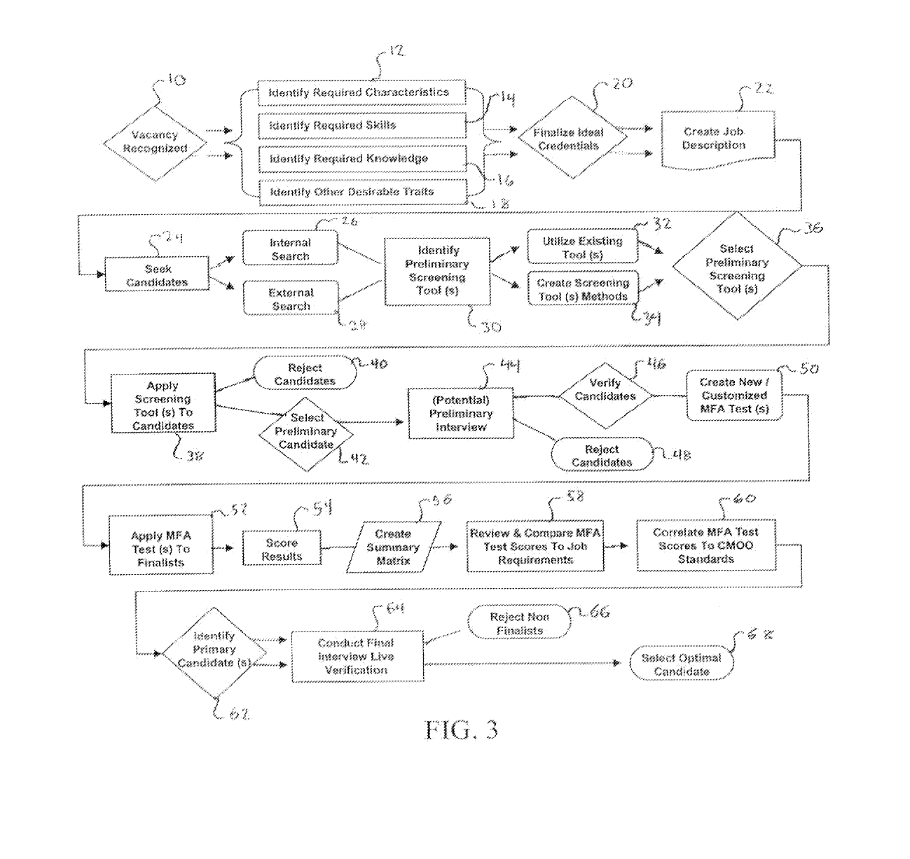

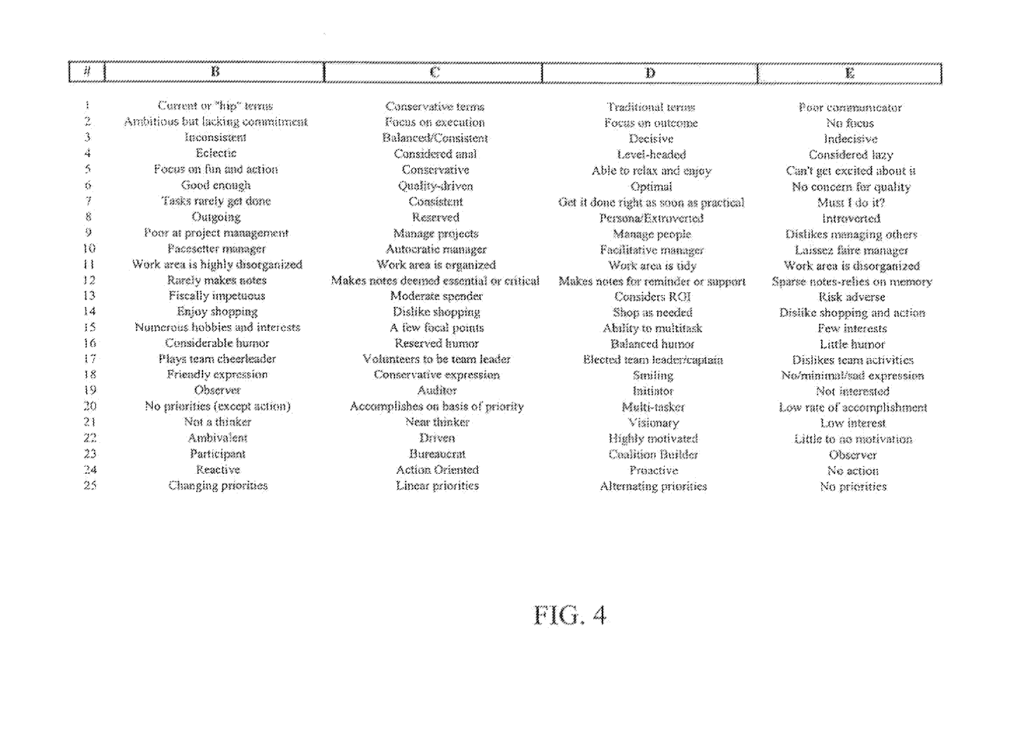

FIG. 3, shows a flow chart illustrating a sample process for establishing categories for a job vacancy and administering the assessment tests in order to evaluate MFA and fill the vacancy. It should be understood that the illustrated method may be implemented manually, or on a computer, and/or a combination of both. At step 10 a company or business recognizes that a position needs to be filled. After a company recognizes that a position needs to be filled those characteristics needed to satisfy the position are established. At step 12 the required characteristics for the vacancy are identified. At step 14 the required skills are identified. At step 16 the required knowledge is identified. At step 18 other desirable traits for the vacancy are determined. This data can be used in order to establish the ideal characteristics of a candidate. The criteria needed for the position can be procured through the means of interviews, questionnaires or other media. A specific index/listing of both required and highly desirable knowledge, traits, skills and characteristics can be established. FIG. 4 shows a table having various character traits that can be used in evaluating MFA of a candidate for job, or indeed for a person in general. The summary of all these elements can be used to provide a profile of an individual. These profiles can be compared to categories selected in advance to ascertain the likelihood of individuals or groups of individuals matched to be successful in achieving a desired goal/task or being placed into a category for treatment by mental health professionals, physicians or both. At step 20 the identified ideal aspects of the vacancies are finalized. At step 22 this information is used to create a description of the vacancy in order to advertise the vacancy.

At step 24, the search for candidates is initiated that can involve both an internal and external search (with respect to the company). At step 26, an internal search is conducted and at step 28 an external search is conducted for potential candidates. At step 30, preliminary screening tools may be used, such as required educational levels, experience levels, etc. At step 32, existing tools for searching for potential candidates are used (agents, media, computers, etc.). At step 34, a company can create new screening tools and methods for identifying potential candidates (improved tests, criteria, etc.). At step 36, a company selects the appropriate preliminary screening tool whether it be a pre-existing screening tool or a new screening tool is used.

At step 38, the screening tools is used to identify candidates. At steps 40 and 42, the candidates are either rejected or selected based upon the preliminary results. At step 44, a preliminary interview may be given to the potential candidates. At step 46 those candidates that pass the initial screening are accepted, while those who do not pass the screening may be rejected in step 48. Both the screening tools and the preliminary interview could use aspects of the MFA assessment procedure, such as sample questions and other initial devices via which the MFA can be probed.

At step 50 the customized MFA test is created for application to the pre-screened candidates. At step 52 the MFA test is applied to the pre-screened candidates. An example of this type of test is shown below in greater detail. The candidates will be tested through the means of defined screening mechanisms (interviews, questionnaires, testing devices, etc.). These tests will result in the accumulation and compilation of information showing their specific set of thinking traits such as focus, awareness, emotion, anxiety, social skills, etc. At step 54, the results of the tests are scored. At step 56, a summary matrix is created to place these scores into separate categories to indicate the differences between their MFA's. At step 58, the MFA test scores will be compared to the job requirements. At step 60, the MFA test scores are compared to the previously established set of required desired characteristics which in turn will generate placement within a set of categories established specifically for the purpose of the evaluation. This placement will be the indicator of how closely the candidate's MFA matches the required/desired category of the goal/task/objective desired. It is possible to normalize the results and compare them to an ideal evaluation and then use the a candidates deviation from the ideal evaluation in order to make a selection.

When performing the comparison, the results of the selected screening/testing methods that have been uniformly administered to each candidate, are “plotted” providing an indication of the degree to which each candidate displays/complies with the established “standard” requirement for performing the COO function. The variations of the test results from each candidate become apparent in this comparative process, allowing the employer to select the best candidate for the position of COO, even to the point of knowing/acknowledging their apparent weaknesses (for which corrective actions could be taken). It is further possible to place numerical values upon various results of the tests and then normalize the raw numbers to a set standard related to the specific application of the MFA assessment.

At step 62, the primary candidate is identified. At step 64, a final interview may be conducted to verify the accuracy of the results and at step 66, non-finalists may be rejected. At step 68, the best candidate is selected.

The test shown below in tables 1 and 2 was designed to detect undesirable decision-making traits or actions for a Chief Operating Officer of a business. It should be noted that, in such a position, candidates should not be too highly focused, e.g. at position 10 on FIG. 2, nor should they lack focus, e.g. position 1 or 2. The test may be administered merely to identify potential deficiencies as a precursor for more in depth interviews, for statistical measurement or to compare results between multiple candidates, etc.

Chief operating officers are most ideally suited for the position when they are democratic, facilitative and coaching in their leadership styles. The selection process should avoid highly focused, rigid, and methodical individuals, people tending to the 10 position on FIG. 2, as well as spontaneous persons with low focus, i.e. people tending towards the 2 position on FIG. 2. Characteristics and skills might include such things as: open mindedness, financial acumen, facilitative leadership, excellent written and verbal communications, good arbitration skills, project management skills, strategic visioning, collaborative mannerism, comprehensive business acumen, assorted technical skills and industry knowledge, results oriented, persuasiveness, etc. etc. The specific set of desired requirement s would be established on a case by case basis to meet the needs of the actual setting/organization.

A simplified (i.e., single indicator) questionnaire is shown below. In an actual application of such a test, the questionnaire/interview guide would be customized to obtain specific insights into the “standards” that have been established. These test/questionnaires might also be constructed so that they would be longer and would incorporate multiple questions of a redundant nature, to help insure that the results more accurately reflects the true MFA.

The following sample questions in Table 1 and 2 below are generic. Questionnaire oriented tests should be prepared (culturally adjusted) on an application-by-application basis by persons with expertise in the given field of endeavor, e.g., healthcare as opposed to retail sales, as opposed to banking, as opposed to manufacturing, etc. The answers A, B, C, D, E and F in the test below correspond to numbers 9, 10, 11, 12, 1 and 2 shown in FIG. 2 and discussed above.

TABLE 1

| | | Choose One | | | | | |
|---|---|---|---|---|---|---|---|
| | | Constantly | Occasionally | Very Often | Often | Rarely | Never |
| 1. | Rather than request the assistance of | A | B | C | D | E | F |
| | support staff, I will prepare analysis on | | | | | | |
| | spreadsheet software if the project | | | | | | |
| | consumes ½ hour or less. | | | | | | |
| 2. | I use lists to stay organized and sort | A | B | C | D | E | F |
| | my priorities. | | | | | | |
| 3. | I arrive promptly at the designated | A | B | C | D | E | F |
| | start time for employees. | | | | | | |
| 4. | Before preparing a plan to execute a | A | B | C | D | E | F |
| | strategy, I must identify who will be | | | | | | |
| | responsible for the task. | | | | | | |
| 5. | I do my own research for a report | A | B | C | D | E | F |
| | requested from me by my boss. | | | | | | |
| 6. | I focus on my career as a means to | A | B | C | D | E | F |
| | have upward mobility with regard to | | | | | | |
| | financial security. | | | | | | |
| 7. | I enjoy leading teams rather than | A | B | C | D | E | F |
| | participating in them. | | | | | | |
| 8. | When I lead teams, the meeting is | A | B | C | D | E | F |
| | confined to the allocated time limit. | | | | | | |
| 9. | When I purchase something which | A | B | C | D | E | F |
| | requires detailed assembly, I read the | | | | | | |
| | directions before starting the task. | | | | | | |
| 10. | I take time to work on hobbies. | A | B | C | D | E | F |
| 11. | I prefer creating ideas rather than | A | B | C | D | E | F |
| | selling them. | | | | | | |
| 12. | I prefer working in a quiet | A | B | C | D | E | F |
| | environment without disruptions. | | | | | | |
| 13. | I think about inventing or | A | B | C | D | E | F |
| | innovating products or concepts. | | | | | | |
| 14. | I delay decisions until data is | A | B | C | D | E | F |
| | available to eliminate risks. | | | | | | |
| 15. | I read books pertaining to my | A | B | C | D | E | F |
| | career. | | | | | | |
| 16. | I use one hobby as a source of | A | B | C | D | E | F |
| | relaxation. | | | | | | |

TABLE 2
Circle which of the following you prefer or best describes you:

| B | C | D |
|---|---|---|
| Concurrent Foci | Mulitple Foci | Changing Foci |
| Managing | Leading | Performing |
| Valuable | Facilitator | Implements |
| Contributor | | |
| Conservative | Decide Based on | Unwilling to |
| | ROI | Take Risks |
| Ownership | Partnership | Worker |
| Reserved | Interactive | Active |
| Vocation based on | Vocation | Employment |
| Recognition | based on | |
| | Enjoyment | |
| Commitment | Passion | Interest |
| Expert Practitioner | Consultant | Team Member |
| Facts and Logic | Logic and | Logic and |
| | Empirical | Assumption |
| | Knowledge | |

The rationale for using the above selected questions is provided below. The rationale for question 1 is that a COO should focus on big picture issues rather than performing rote tasks. While a COO may want to avoid burdening his/her staff as a means of displaying sincere interest in their workload, such decisions cause an imbalance in responsibility. Eventually, staff may expect their manager to perform such tasks. Furthermore, the desire to perform spreadsheet tasks may be an indicator of focusing on tasks they enjoy as opposed to other required duties.

rationale for question 2 is that in some form or through some mechanism, the preparation of lists is essential for executives in order to sort through priorities and maintain a tally of the work-in-progress. In addition to being a means of opening a dialogue about task prioritization and delegation, this question also enables the employer to assess the possibility that the candidate may have a cavalier attitude with regard to the need for maintaining a big picture view of tasks at hand.

The rationale for question 3 is that the question enables the employer to gain insight into how the person gauges the importance for employees to comply with regulations and rules. Follow-up discussion will also provide insight into the leadership style of the candidate, i.e., command and control, pacesetting or democratic/facilitative/coaching.

The rationale for question 4 is that executives, should always refrain from focusing on who will perform a task until the detailed requirements have been identified. Only then should an attempt be made to find the right individual to match the task. Selecting the individual first can indicate numerous shortcomings, e.g., being able to trust only a few individuals with important tasks, being unwilling to spend the time to research an plan a strategy appropriately, the desire to place haste over a quality outcome, etc. This question enables the employer to gain added insight into how the candidate organizes strategy execution.

The rationale for question 5 is that this question is intended to provide an indicator as to whether or not the candidate is a perfectionist and possibly over focused. It also provides an indicator regarding the person's willingness to delegate authority.

The rationale for question 6 is that a COO should focus on their career. However, they should place an emphasis on the performance and outcome generated by the employees. This question is intended to generate discussions to ascertain whether or not the candidate is so over focused on their career and their personal actions instead of possessing and using the interpersonal skills essential for their ability to perform at a level of optimal effectiveness as a COO.

The rationale for question 7 is that an effective COO will usually prefer to lead a team. In such a position, the COO can provide training, education, build morale, etc. the employer will have to delve deeply into any candidate who prefers to be a member of a team instead of leading it. The detailed answer to the follow-up question will provide further insight into the categorization of how the candidate thinks.

The rationale for question 8 is that the question is intended to provide an indicator of the candidate's leadership style. If the candidate is focused on time constraints, it is a strong indicator that they are a command and control leader who is over focused or focused on data as opposed to outcomes and employee morale. A COO who desires building effective teams will allow flexibility for the length of the meeting, especially if its intent is to gain input and opinions of the attendees. Rushing a meeting is one of the major pitfalls when an executive is asking attendees to participate and truly contribute to outcomes.

The rationale for question 9 is that avoidance of following detailed written instructions can be a strong indicator of the lack of focus. On the other hand, follow-up discussions can also provide insight into whether or not the candidate may be so over focused that they must accomplish all tasks in a methodical, step-by-step basis.

The rationale for question 10 is that the question is intended to determine whether or not the candidate has any other diversions as a means of shifting focus. It opens the discussion to ascertain the level of focus the individual may place or their hobby, i.e., are they obsessed with it or is it merely a means to shift focus in order to relax? Individuals without hobbies can be questioned to ascertain why they chose not to be one? The answers to these follow-up questions will provide further insight into the category of though processes of the candidate.

The rationale for question 11 is that while this question would be an ideal means to screen for individuals who could fill a role involving innovation. As a COO, however, an individual should focus on the need for and their ability to get others to do what they want them to do; i.e., the ability to sell change. The question provides an indicator regarding the candidate's motivation; think or lading as well as focus or awareness.

The rationale for question 12 is that a COO will be the hub of activity in an organization. If the candidate indicates a leaning toward quiet and solitude, they may be over focused on issues and may be more ideally suited for production or research rather than leadership.

The rationale for question 13 is similar to number 11. A COO should care about innovation but nit view their position as being the one which can and should initiate innovation. A COO's focus should be on identifying individuals who can fill this role and encouraging them to do so.

The rationale for question 14 is to gauge whether or not the candidate is on either end of the risk assessment scale, i.e., unable to make decisions because hard facts and data aren't available or they are willing to accept levels of risk disproportionate to the level identified by the employer.

The rationale for question 15 is to search for several indicators. Does the person read frequently and if so, what kind of material? If they do not read frequently, it could ben indicator of mild depression or a strong focus on another activity. If they do read “self-help” books pertaining to their career, discussions pertaining to those books can provide insight into the candidates self image and/or possible areas of weakness.

The rationale for question 16 is to be a second level of assessment of the extent of an individual's focus. It should be used as a means of validating the answer to question 10.

The rationale for question 17 is that due to the need for a COO to remain flexible and to set a positive image regarding their willingness and ability to make decisions easily, this question is included as a second level of investigation (in addition to question 14).

The rationale for question 18 is that this question will provide indicators for the placement of the candidate into the category of how they think. Follow-up questions should address their opinion or definition of quality and the value they place on it. It can also provide indicators for their motivation behind career selection as well as their future direction.

The rationale for question 19 is that a COO should be capable of performing detailed tasks on an as needed basis. Discussions should center on how much the candidate “enjoys” detailed work. On the other hand, if the dislikes detail, the possibility of a deficiency in focus exists.

The rationale for question 20 is that a COO should be capable of reading and interpreting “technical and academic” papers pertaining to their field of endeavor. Discussions should follow on the degree of interest in such details the candidate has. In other words, is their focus on the details of a project or concept as opposed to the leadership of personnel and activities associated with internal collaboration and coordination to accomplish the corporation's objectives?

The rationales provided above are only exemplary in nature and different organizations may tailor their tests based upon their desired qualities.

### EXAMPLE 2

The following example is an evaluation of Applicants for Commercial Pilot's License. While candidates for a commercial pilot's license will have already been tested to ascertain their intellectual competence and, as part of the licensing process, would be required to be evaluated with regard to their physical capabilities, little if any, testing may be given related to characteristics that are expressed as part of MFA. While some employers may require licensed commercial pilots to undergo a series of psychological testing, these “profiles” do not take into account the possible consequences of some aspects of MFA, such as over focusing, which is an aspect of psychology not addressed as part of standard psychological and psychiatric evaluations. Accordingly, the following example test, shown below in Table 3, is designed to evaluate the possibility of an applicant for a commercial pilot's license having an MFA that indicates that the candidate is over focused. In addition, the test also includes several questions which can be used to ascertain the possibility that the individual may be suffering from clinical depression.

It should be noted that testing of this type is merely intended to be a assessment indicator to ascertain whether or not the person displays the characteristics of the mental functioning activity which may disqualify them from being suited to transport personnel commercially. For the purpose of this test example, the mental functioning activity results were grouped into three categories, over focused, proportionately focus to perform the task adequately and under focused.

TABLE 3
Questions

1. Do you have any hobbies? Yes No

a. If yes, how many do you pursue on a regular basis?
b. If yes, what are they?

2. I view change in the following manner:

a. As a nuisance
b. As a necessary but annoying process
c. As something which helps me progress
d. As an activity which enables me to have variety in my life

3. My leadership style would best be described as

a. hierarchal (as in organizational chart based)
b. democratic
c. empowerment based
d. pacesetter/results oriented

4. I actively watch the following sports:

Not interested in organized sporting activities

5. I want a commercial pilot's license because it:

a. enables me to earn a substantial income
b. allows me to fly frequently while being paid for the activity
c. allows me to travel extensively
d. fulfills the fun I have flying
e. other: (specify)

6. Other than books related to the study of flying, approximately how many other books have
you read in the past two years?
a. What topics did they address (specify the number in each category)

Fiction

science fiction
adventure
politics
romance/travel
other (specify)
other (specify)

Non-Fiction

history
geography/travel
science (health, medicine, etc)
self-help
biographies/autobiographies
other (specify)
other (specify)

7. Do you read, in detail, newspapers or magazines on a regular basis?

Yes No
If yes, approximately how many magazines do you read on a monthly basis?
If yes, how many newspapers do you read on a weekly basis?

8. If you were a member of a team assigned to prepare a business plan and were allowed to select
your personal role, which area of focus would you select? (Circle One)

a. WHY
b. WHAT
c. WHEN
d. WHERE
e. HOW
f. WHO

9. Other than being a commercial pilot, I would prefer a career which involves:

a. research
b. planning
c. managing (leading)
d. marketing (internal)
e. sales (external)
f. production

10. Which of the following activities would best describe your business interests (other than
commercial flying?)

a. investor
b. owner
c. partner
d. entrepreneur

11. I generally pick my friends based on which of the following attributes:

a. intelligence
b. career
c. social activities
d. humor
e. their culture or traditions

12. My desk or personal work area would be best described as being:

a. highly organized
b. neat
c. somewhat disorganized
d. disorganized
e. sloppy

13. When I purchase something which requires assembly, I usually

a. assemble it without reading the directions
b. check the directions as a guide prior to undertaking the project
c. follow the directions loosely
d. follow the directions exactly, step-by-step

14. My humor would be described as:

a. very reserved
b. slightly more humorous than average
c. average
d. highly active
e. a prankster

15. If I were a gambler (whether you gamble or not) my choice of activities would be:

a. card games
b. roulette
c. dice/craps
d. sports betting
e. slot machines

16. How many personal vacation trips have you taken over the past three years?

a. six or more
b. five or less
c. four or less
d. three or less
e. two or less

What were the destinations?

17. Do you exercise on a regular basis? Yes No

a. If yes, how many times per week?
b. What forms of exercise do you use?
c. How many hours per week do you spend?

18. My decision making process involves using facts to what percent?

a. 100%
b. whenever available, then 100% logic
c. whenever available, then a combination of logic and assumption
d. same as “c” but incorporating intuition as well

19. My level of creativity would best be described as:

a. inventor
b. innovator
c. designer
d. decorator

20. If for whatever reason I was unable to be a commercial airline pilot, excluding income,
which of the following would describe my choice of careers (assuming that you had the
necessary education)

a. scientist
b. lawyer
c. physician
d. surgeon
e. politician
f. sales/marketing executive
g. business/industry executive
h. career involving activities in nature/the outdoor

### EXAMPLE 3

Another way of using MFA is to use it in establishing and diagnosing the overall health of an individual. The usage of MFA can be correlated to take into account the metabolic aspects of a person. The metabolic rate of various organs can be ascertained using various tests, etc. This can be correlated to with the MFA of an individual. Based upon these correlations it can be determined to what extent MFA affects the metabolic rate of an individual. This can be further expanded upon in order to determine how MFA affects the usage of medication on individuals, and on specific organs and glands. For example someone consuming moderate amounts of caffeine would experience an increased heart rate as well as an increase in their mental function activity.

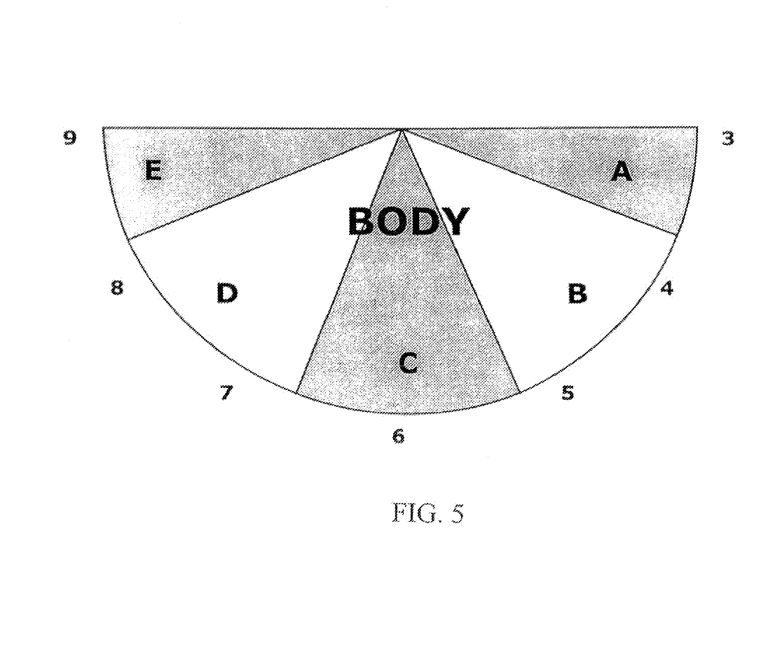

FIG. 5 shows the bottom portion of a clock face that functions in the same way that the top face of the clock face functions in FIG. 2 with respect to the mental functioning activity of an individual. The bottom portion of the clock face represents the spectrum of physical health and activity, this can be referred to as body functioning activity. Numbers 9 to 3 correspond to in ascending order on the clock graphic from high activity or metabolic rate, strong physicality, high immune system and high organ or gland performance to low activity or metabolic rate, weak physicality, poor immune system and poor organ or gland performance. Categories A-E, are alternatively categories that represent high activity or metabolic rate, strong physicality, high immune system and high performance of organs or glands to low activity or metabolic rate, weak physicality, poor immune system and poor organ or gland performance.

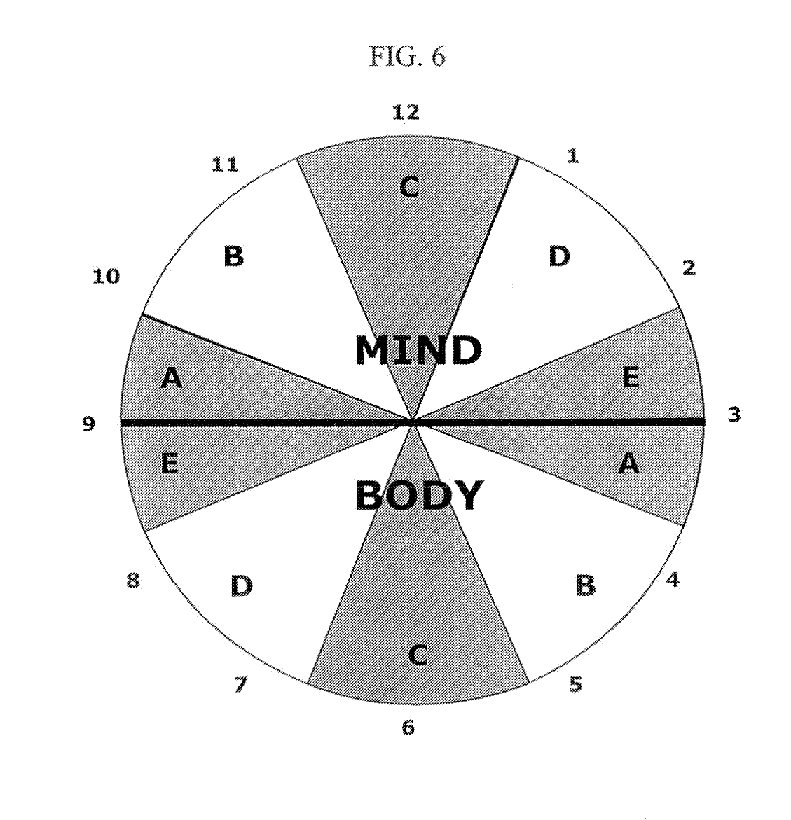

The chart shown in FIG. 5 can be used in conjunction with the chart used in FIG. 2, by a physician in order to illustrate to a person a complete view of their health. FIG. 6 shows both the top portion and the bottom portion used together. The clock in FIG. 6 can easily illustrate to a person what their overall health status is, both mental and physical.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the board general meaning of the terms in which the appended claims are expressed.

What is claimed is:

1. A method for selecting an individual for a position of employment comprising the steps of:
establishing characteristics applicable to a position of employment;
preparing a mental function activity test based on the characteristics;
administering the mental function activity test to a pool of potential employees;
assessing results of the mental function activity test; and
selecting an employee based upon the results of the mental function activity test.

2. The method of claim 1, wherein the characteristics are used to establish a profile of a predetermined ideal employee.

3. The method of claim 2, wherein the results are normalized based upon the profile of the predetermined ideal employee.

4. The method of claim 1, wherein the results are analyzed on a matrix.

5. The method of claim 1, wherein the mental function activity test is administered on a computer.

6. The method of claim 1, further comprising administering a preliminary screening test to the pool of potential employees before the step of administering the mental function activity test.

7. The method of claim 6, further comprising selecting more than one individual from the pool of potential employees based upon the step of administering the mental function activity test.

8. The method of claim 7, further comprising administering an oral interview to the individuals selected from the pool of potential employees based upon the step of administering the mental function activity test.

9. The method of claim 1, wherein the position is an executive position.

10. The method of claim 1, wherein the step of assessing the results of the mental function activity test further comprises establishing categories that correspond to positions on a clock.

11. The method of claim 1, wherein the steps of administering the mental function activity test and assessing the results of the mental function activity test are performed using a computer.

12. A method for categorizing assessment results of mental function activity comprising the steps of:
establishing a plurality of categories based upon a pool of characteristics;
organizing the plurality of categories to correspond to a clock face;
administering a test to a person;
evaluating results of the test administered to the person; and
utilizing t he results to place the person into one of the plurality of categories.

13. The method of claim 12, wherein characteristics are selected from a pool consisting of ability to focus, temperament; concern, happiness, and physical activity.

14. The method of claim 12, wherein the category in which the person is placed is used to determine if the person is suitable for a position of employment.

15. The method of claim 12, wherein the test is selected from a group consisting of questionnaires and interrogatories.

16. The method of claim 12, the step of administering the test is accomplished by using a computer.

17. A method for assessing a mental function activity of an individual comprising:
applying a test to an individual, wherein the test is designed to illustrate mental function activity characteristics; and
evaluating results of the test, wherein the results are used to place the individual into a category and the category represents a level of mental function activity.

18. The method of claim 17, wherein the metal function activity characteristics are selected from a group consisting of ability to focus, temperament; concern, happiness, and physical activity.

19. The method of claim 18, wherein the test is selected from a group consisting of questionnaires and interrogatories.

20. The method of claim 18, wherein the test is performed using a brain imaging device.
